(19) United States
(12) Patent Application Publication
(10) Pub. No.: US 2026/0149610 A1
(43) Pub. Date: May 28, 2026

(54) ELECTRONIC DEVICE

(71) Applicant: SEIKO EPSON CORPORATION, TOKYO (JP)

(72) Inventor: Keisuke NISHIDA, KITAKYUSHU-SHI (JP)

(21) Appl. No.: 19/396,904

(22) Filed: Nov. 21, 2025

(30) Foreign Application Priority Data
Nov. 22, 2024 (JP) 2024-203933

(51) Int. Cl. H04L 12/10; H04L 12/12

(52) U.S. Cl. CPC H04L 12/10; H04L 12/12

(57) ABSTRACT

An electronic device includes a wired LAN communication section configured to communicate with an external device (for example, a PC); a wireless LAN communication section configured to communicate with an external device; and a control section. The control section supplies power to the one communication section that was selected from the wired LAN communication section or the wireless LAN communication section, and does not supply power to the other communication section that was not selected.

The present application is based on, and claims priority from JP Application Serial Number 2024-203933, filed November 22, the disclosure of which is hereby incorporated by reference herein in its entirety.

### BACKGROUND

### 1. Technical Field

The present disclosure relates to an electronic device having a plurality of types of communication sections.

### 2. Related Art

For example, a method is disclosed in US 2005/0188232 A1 of managing power consumption of a network interface. In this management method, when the user disables a wake-up function, supply of the power supply and of the clock signal to the MAC and PHY reception terminals can be cut off. When the user enables the wake-up function, the power and a clock signal may be provided to the receiver of the medium access control unit and the receiver of the physical layer unit.

However, there is a problem that there is room for improvement in suppression of power consumption in an electronic device configured to be able to select a plurality of types of communication sections.

### SUMMARY

An electronic device that solves the above problem includes a wired LAN communication section configured to communicate with an external device; a wireless LAN communication section configured to communicate with an external device; and a control section, wherein the control section supplies power to one communication section that was selected between the wired LAN communication section and the wireless LAN communication section and does not supply power to the other communication section.

### BRIEF DESCRIPTION OF THE DRAWINGS

FIG. 1 is a perspective view illustrating an electronic device according to an embodiment.

FIG. 2 is a schematic perspective view illustrating a rear face of the electronic device.

FIG. 3 is a block diagram illustrating an electrical configuration of the electronic device.

FIG. 4 is a schematic diagram illustrating a program stored in the ROM.

FIG. 5 is a schematic diagram illustrating a functional configuration of a control section.

FIG. 6 is a circuit block diagram illustrating an electrical configuration related to USB communication between the electronic device and the external device.

FIG. 7 is a circuit block diagram illustrating an electrical configuration related to wired LAN communication between the electronic device and the external device.

FIG. 8 is a circuit block diagram illustrating an electrical configuration related to wireless LAN communication between the electronic device and an external device.

FIG. 9 is a schematic diagram illustrating a selection screen that can be set when the power supply of the electronic device is activated.

FIG. 10 is a schematic diagram illustrating communication setup information stored in a non-volatile memory.

FIG. 11 is a schematic diagram illustrating communication setup information stored in a non-volatile memory.

FIG. 12 is a schematic diagram illustrating communication setup information stored in a non-volatile memory.

FIG. 13 is a flowchart illustrating a communication section power supply control routine.

FIG. 14 is a schematic diagram illustrating a selection screen displayed on the external device.

FIG. 15 is a schematic diagram illustrating a selection screen displayed on the electronic device.

FIG. 16 is a flowchart illustrating a USB power supply control routine.

### DESCRIPTION OF EMBODIMENTS

Hereinafter, an electronic device according to an embodiment will be described with reference to the drawings.

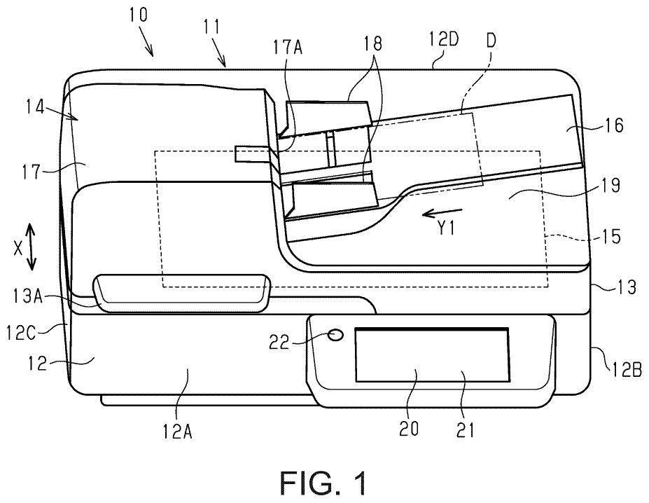

As illustrated in FIG. 1, an electronic device 10 is configured to communicate in two or more communication methods including wired local area network (LAN) communication and wireless LAN communication. The electronic device 10 is, for example, an image reading device 11 (scanner). In the present embodiment, a characteristic configuration and function related to communication of the electronic device 10 will be described using the image reading device 11 illustrated in FIG. 1 as an example.

### Configuration of Image Reading Device 11

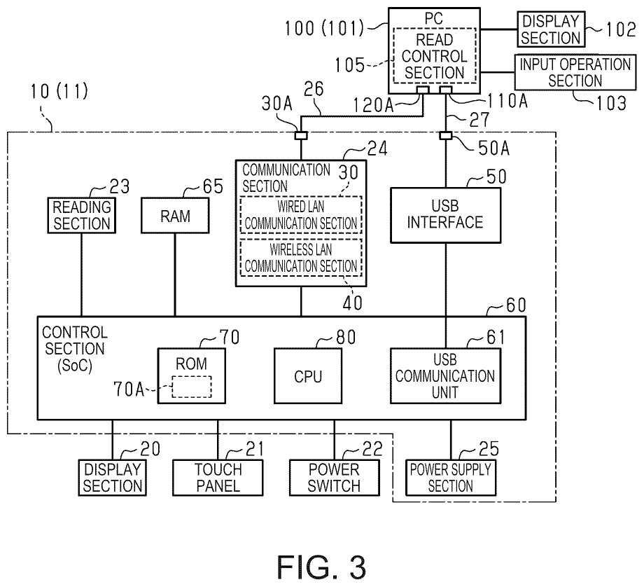

As illustrated in FIG. 1, the image reading device 11 includes a main body 12 having a rectangular parallelepiped shape, and a cover 13 provided to be openable and closable with respect to an upper surface of the main body 12. The main body 12 has a front face 12A, a right side 12B, a left side 12C, and a rear face 12D. The cover 13 is provided with an automatic-document feeder 14. The cover 13 is provided with a handle 13A. The user can open and close the cover 13 by using the handle 13A. When the cover 13 is opened, a platen glass 15 disposed on the upper surface of the main body 12 is exposed. The user sets the document D on the platen glass 15 and then closes the cover 13 to press the document D. In this state, the image of the document D on the platen glass 15 is read by a reading section 23 (see FIG. 3) that moves in the scanning direction below the platen glass 15.

The automatic-document feeder 14 includes a document support 16 on which the document D is placed (set), and a feeding section 17 that feeds the document D set on the document support 16 one sheet at a time. The document support 16 is provided with a pair of edge guides 18 that are slidable in a width direction X, which intersects (particularly, is orthogonal to) a transport direction Y1 in which the document D is transported. The document D on the document support 16 is positioned in the width direction X with respect to a feed port 17A by being sandwiched between the pair of edge guides 18. The document D fed by the automatic-document feeder 14 is read by the reading section 23 at a reading position in the middle of the transport path, and then discharged to a discharge section 19 arranged on the upper surface of the cover 13 below the document support 16.

As illustrated in FIG. 1, the image reading device 11 includes a display section 20 and a touch panel 21, which is an example of an operation section. The touch panel 21 is an input section that allows a user to perform an input operation by touching the touch panel 21. The display section 20 is arranged at a position that can be visually checked by the user from an operation position where the user operates the electronic device 10, for example. The display section 20 may be arranged on an operation panel provided on the front section of the main body 12. The electronic device 10 includes a power switch 22 that can be operated by a user. The operation section may include one or more operation switches in addition to the touch panel 21 or instead of the touch panel 21.

The electronic device 10 has a communication function is configured to communicate with an external device 100 (see FIG. 3). The electronic device 10 is compatible with a plurality of types of communication methods. The external device 100 can communicate with the electronic device 10 in at least one communication method. The electronic device 10 receives instruction data from the external device 100 by communication. The image reading device 11, which is an example of the electronic device 10, accepts (receives) scan setups from the external device 100 and transmits image data obtained by reading a document D to the external device 100 by communication using a wired or wireless communication method.

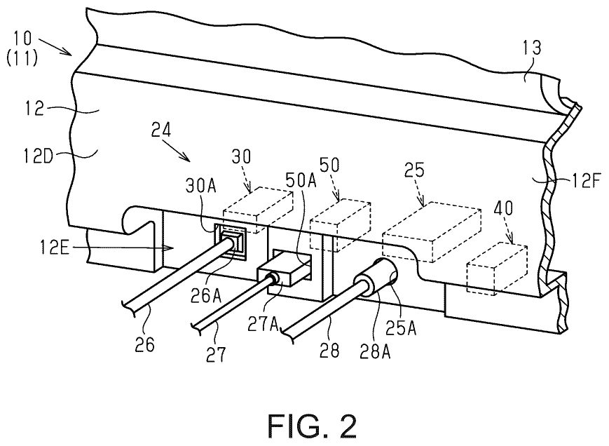

As illustrated in FIG. 2, the electronic device 10 includes a communication section 24 in the main body 12. The communication section 24 includes a wired LAN communication section 30 and a wireless LAN communication section 40. The electronic device 10 may include a third communication section other than the wired LAN communication section 30 and the wireless LAN communication section 40. The third communication section is a universal serial bus (USB) communication section in the present embodiment. The USB communication section is configured by a USB interface 50. Therefore, the USB communication section is also referred to as a USB communication section 50 below.

As illustrated in FIG. 2, the wired LAN communication section 30, the wireless LAN communication section 40, and the USB communication section 50 are provided, for example, in a portion on the rear face 12D side of the main body 12. The three types of communication sections 30, 40, and 50 may be arranged in, for example, a port placement region 12E in the lower portion on the rear face 12D side. The three types of communication sections 30, 40, and 50 and a power supply section 25 may be arranged in the port placement region 12E. The three types of communication sections 30, 40, and 50 and the power supply section 25 may be arranged side by side in the width direction X. The arrangement position of each of the three types of communication sections 30, 40, and 50 is not limited to the rear face 12D side of the main body 12, and may be an appropriate position on another surface side.

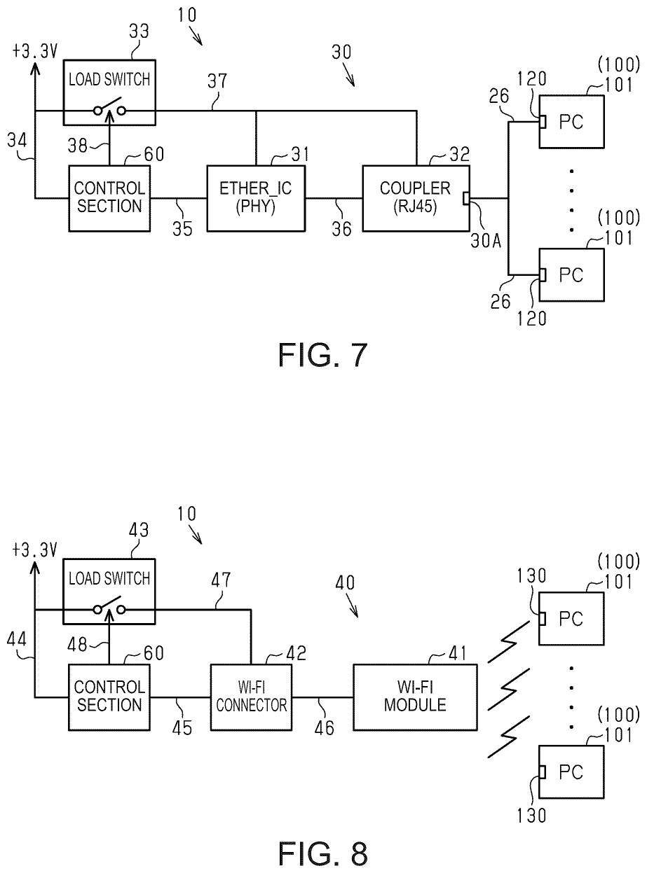

The wired LAN communication section 30 has a LAN port 30A exposed from the main body 12. The LAN port 30A is connectable with a LAN cable 26. Both end sections of the LAN cable 26 has a plug 26A (only one plug is illustrated in FIG. 2). One plug 26A of the LAN cable 26 can be connected to the LAN port 30A. The other plug 26A of the LAN cable 26 is connected to a LAN port of a second wired LAN communication section 120 (see FIG. 7) on the external device 100 side. By this, the electronic device 10 and the external device 100 are communicably connected to each other through the LAN cable 26.

The wireless LAN communication section 40 is housed in a housing 12F constituting the main body 12. The wireless LAN communication section 40 is, for example, a Wi-Fi communication section.

The USB interface 50 is connected to the external device 100 in a wired manner to enable communication with the external device 100. The USB interface 50 functions as the USB communication section 50 that enables communication between the electronic device 10 and the external device 100 when the electronic device 10 is connected to the external device 100 via a USB cable 27.

The USB interface 50 has a USB port 50A exposed from the main body 12.

In the USB port 50A, one USB plug 27A of the USB cable 27 can be connected.

The other plug 27A of the USB cable 27 is connected to a USB port 110A (see FIG. 3) on the external device 100 side.

The power supply section 25 illustrated in FIG. 2 includes a power port 25A exposed from the main body 12. A power plug 28A at one end section of a power cable 28 is connectable to the power port 25A. The other end section of the power cable 28 is connected to an AC power supply via a rectifier. The power supply section 25 converts a voltage supplied via the power cable 28 into a plurality of types of predetermined voltages. The power supply section 25 supplies a predetermined voltage corresponding to a rated voltage to each section in the electronic device 10.

In FIG. 2, the communication cables 26 and 27 are connected to the ports 30A and 50A, respectively, but the communication method to be used differs depending on the user. When the communication method to be used is the wired LAN communication section 30, the user connects (inserts) the plug 26A of the cable 26 to the LAN port 30A. When the communication method desired to be used is the wireless LAN communication section 40, the user may not connect (insert) the cable 26 to the LAN port 30A. At least one of the cables 26 or 27 may be kept in a state where the plug is connected to the port. The LAN can be connected to a plurality of external devices 100 compatible with the wired LAN at the same time. Therefore, the plug 26A of the LAN cable 26 is frequently kept connected to the LAN port 30A. On the other hand, the USB is usually connected to the external device 100 using the USB cable 27. The frequency of the plug 27A of the USB cable 27 being kept inserted in the USB port 50A is relatively low. When the user wants to perform USB communication, the user inserts the plug 27A of the USB cable 27 into the USB port 50A. However, the presence or absence of the connection of each cable 26 and 27 depends on the way of use by the user.

### Electrical Configuration of Electronic Device and External Device

Next, an electrical configuration of the electronic device 10 and the external device 100 will be described with reference to FIG. 3. As illustrated in FIG. 3, the external device 100 may be a personal computer 101 (hereinafter also simply referred to as the “PC 101.)” The external device 100 may include a display section 102 that functions as a notification section, and an input operation section 103. The display section 102 may be a liquid crystal display panel, an organic EL display section, or the like. The display section 102 may have a touch panel function. In this case, the touch panel 21 may constitute at least a part of the input operation section 103.

The input operation section 103 may include a keyboard or a pointing device such as a mouse. The external device 100 is not limited to the PC 101 illustrated in FIG. 3, and may be a smartphone, a cellular phone, a personal digital assistant (PDA), a tablet PC, or the like.

The external device 100 may include the second wired LAN communication section 120 (see FIG. 7) and a second wireless LAN communication section 130 (see FIG. 8) configured to be able to communicate with the wired LAN communication section 30 and the wireless LAN communication section 40 of the electronic device 10. The external device 100 may include only either the second wired LAN communication section 120 or the second wireless LAN communication section 130.

As illustrated in FIG. 3, the electronic device 10 is communicably connected to the external device 100 via the communication section 24 The electronic device 10 can communicate with the external device 100 via a wired LAN through the LAN cable 26 or wirelessly via a wireless LAN. The electronic device 10 can perform USB communication with the external device 100 by the USB interface 50 being connected to the external device 100 through the USB cable 27. The user who selects USB communication connects the electronic device 10 and the external device 100 through the USB cable 27.

The external device 100 (the PC 101) includes a read control section 105 configured by internal software by installing a scan driver program. The read control section 105 includes a scan driver. The read control section 105 causes the electronic device 10 to perform a predetermined operation. The read control section 105 functions as a second control section that gives an instruction to the electronic device 10 via communication. The external device 100 includes the second communication section that is either the second wired LAN communication section 120 (see FIG. 7) capable of communicating with the wired LAN communication section 30 of the electronic device 10 or the second wireless LAN communication section 130 (see FIG. 8) capable of communicating with the wireless LAN communication section 40. The PC 101, which is an example of the external device 100, includes the second wired LAN communication section 120 and the second wireless LAN communication section 130 as the second communication section. The external device 100 further includes a USB communication section 110, which is an example of a third communication section on the external device 100 side, capable of communicating with the USB communication section 50, which is an example of a third communication section on the electronic device 10 side.

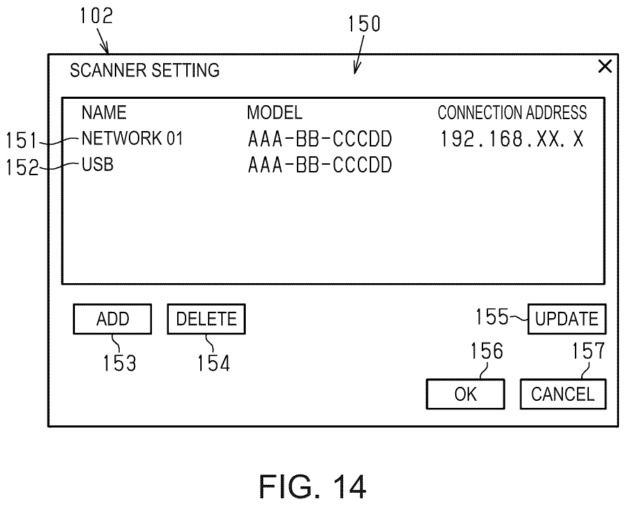

In the present embodiment in which the electronic device 10 is the image reading device 11, the read control section 105 has a function of instructing the image reading device 11 to read the document D. The read control section 105 has a function of transmitting reading instruction information (scan job data) including reading condition information and various commands designated by the user through an operation of the input operation section 103 of the external device 100 to the image reading device 11. That is, the user can instruct the electronic device 10 to perform a predetermined operation (for example, a reading operation) using the touch panel 21, which is an input operation section on the electronic device 10 side, and can instruct the electronic device 10 to perform a predetermined operation (for example, a reading operation) using the input operation section 103 on the external device 100 (the PC 101) side, which has the read control section 105. The read control section 105 has a function of displaying various selection screens on which the user can input or select a value to be instructed or set to the electronic device 10. The read control section 105 has a function of displaying a selection screen (not illustrated) for selecting a value of operation condition information (for example, reading condition information) for instructing a predetermined operation from the external device 100. The read control section 105 has a function of displaying a selection screen (see FIG. 14) for performing setup and selection related to communication with the electronic device 10. When the external device 100 is designated as the transmission destination of the image data, the read control section 105 receives the image data of the document D acquired by the electronic device 10 through the predetermined operation from the electronic device 10.

The electronic device 10 includes the communication section 24 described above. The communication section 24 includes the wired LAN communication section 30 capable of communicating with the external device 100, and the wireless LAN communication section 40 capable of communicating with the external device 100.

The wired LAN communication section 30 is, for example, an Ether IC 31 (PHY) and a connector 32 (RJ45) (refer to FIG. 7 for both). The wired LAN communication section 30 may include a wired communication section other than the Ether IC 31 as long as the wired LAN can be configured.

The wireless LAN communication section 40 is configured by, for example, a Wi-Fi module 41 and a Wi-Fi connector 42 (see FIG. 8 for both). The wireless LAN communication section 40 may include a wireless communication section other than the Wi-Fi module 41 as long as the wireless LAN communication section can configure a wireless LAN.

The electronic device 10 includes a control section 60. The control section 60 may include, for example, a ROM 70 and a CPU 80. The control section 60 is not limited to a control section that performs software processing for all the processes it executes. For example, the control section 60 may include a dedicated hardware circuit, for example, an application specific integrated circuit (ASIC), that performs hardware processing for at least a part of the processing executed by itself. In other words, the control section 60 can be configured as a circuit (circuitry) including one or more processors that operate according to a computer program (software), one or more dedicated hardware circuits that execute at least a part of various processes, or a combination thereof. The processor includes a CPU and a memory, such as a RAM and a ROM, and the memory stores program code or instructions configured to cause the CPU to execute processes. The memory, that is, a computer-readable medium, includes any available medium that can be accessed by a general purpose or special purpose computer.

The control section 60 may be, for example, a System-on-a-chip (SoC) including the ROM 70 and the CPU 80. The electronic device 10 includes a USB communication unit 61. The USB communication unit 61 may be a part of the SoC. The control section 60 may not be the SoC. In this case, the ROM 70, the CPU 80, and the USB communication unit 61 may be mounted on a single circuit board such as a motherboard. The USB communication unit 61 may be mounted on another circuit board different from the SoC including the ROM 70 and the CPU 80.

The electronic device 10 includes the USB communication unit 61 that functions as a detection section that detects a communicable connection of the external device 100 to the USB communication section 50, which is an example of a third communication section. The USB communication unit 61 may be included in the SoC constituting the control section 60. The USB communication unit 61 is, for example, a USB device.

A RAM 65 is connected to the control section 60 via a bus. The RAM 65 temporarily stores the read data by the reading section 23, the image to be processed, and the like for the read data. The ROM 70 comprises a non-volatile memory 70A, for example a rewritable EEPROM memory and the like. The programs and the date stored in the non-volatile memory 70A can be saved even when the power of the electronic device 10 is cut off, and can be rewritten.

In a case where the electronic device 10 is the image reading device 11, the reading section 23 is connected to the control section 60. The control section 60 may cause the reading section 23 to perform a reading operation of reading a document, or may generate image data in a predetermined format by performing predetermined image processing on read data input from the reading section 23. The image reading device 11 may be configured to be able to receive a file format and a transmission destination of image data. The image reading device 11 can receive a reading job including reading conditions instructed by a user operating an input operation section including the touch panel 21.

That is, the user can give a reading job to the control section 60 in the image reading device 11 by operating the touch panel 21. The user can give a reading job to the control section 60 from the external device 100 via wired or wireless communication by operating the input operation section 103 of the external device 100 communicably connected to the image reading device 11.

In both cases of the operation from the touch panel 21 and the operation from the input operation section 103 of the external device 100, the reading job includes reading condition information that defines a reading operation that the control section 60 causes the reading section 23 to perform. The reading condition information may include various condition data related to a document size, a reading surface (single-sided/double-sided), a reading color (color/monochrome/grayscale), a file format, and a transmission destination. The file format may include at least one of a PDF format, a JPEG format, a Tiff format, a GIF format, and a PNG format.

The file format may be a compressed format or a non-compressed format. In the case of the compressed format, the format may be “lossless compression” or “lossy compression”. The JPEG format is an example of the lossy compression format, and the PNG format or the GIF format is an example of the lossless compression format.

The external device 100 can be designated as the transmission destination. The external device 100 may be the PC 101 illustrated in FIG. 3, a smartphone, a cellular phone, a personal digital assistant (PDA), a tablet PC, or the like.

The user may be able to designate a method of transmitting image data as one of the scan setups (reading condition information). The transmission method may be at least one of mail transfer for designating a mail address of a transmission destination, data transfer for storing data in a folder of the external device 100 via wired or wireless communication, and a method for storing data in a USB memory connected (inserted) to a USB terminal.

The display section 20, the touch panel 21, the power switch 22, the reading section 23, the power supply section 25, the RAM 65, the wired LAN communication section 30, the wireless LAN communication section 40, and the USB interface 50 are electrically connected to the control section 60. The RAM 65 temporarily stores image information obtained by reading the document D by the reading section 23. The RAM 65 is used for reading and writing when a predetermined image processing is performed on the image. The predetermined image processing includes cutting processing, inclination correction processing, rotation processing, blank paper removal processing, file format conversion processing, and the like.

The control section 60 supplies power to the selected communication section of the wired LAN communication section 30 and the wireless LAN communication section 40, and does not supply power to the communication section that is not selected. In other words, the control section 60 includes a switch capable of supplying power to the physical layer of the communication section selected from the wired LAN communication section 30 and the wireless LAN communication section 40. The control section 60 turns on the switch corresponding to the selected communication section, either the wired LAN communication section 30 or the wireless LAN communication section 40, and turns off the switch corresponding to the communication section that is not selected.

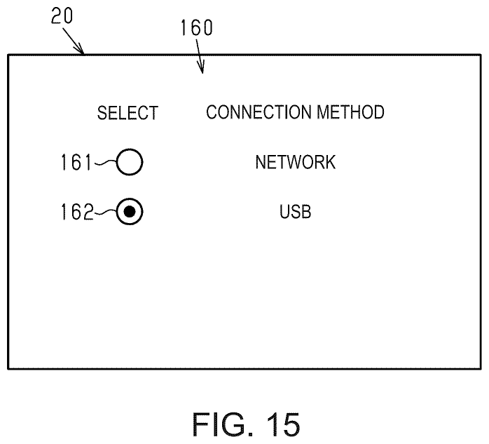

The USB communication unit 61 functions as a detection section that detects the connection between the electronic device 10 and the external device 100 when the plug 27A of the USB cable 27 is connected to the USB port 50A. When the control section 60 detects that the plug 27A of the USB cable 27 is connected to (inserted into) the USB port 50A, the control section 60 shows selection screens 150 and 160 (see FIGS. 14 and 15) to confirm with the user whether or not to select the USB communication on the display sections 20 and 102. When the USB communication is selected, the control section 60 turns off the switches corresponding to the wired LAN communication section 30 and the wireless LAN communication section 40. The control section 60 performs communication section power supply control by supplying power to the one communication section 30 or 40 that was selected, and not supplying power to the other communication section that was not selected, through execution of a program stored in the ROM 70 using the CPU 80.

### Configuration of ROM 70

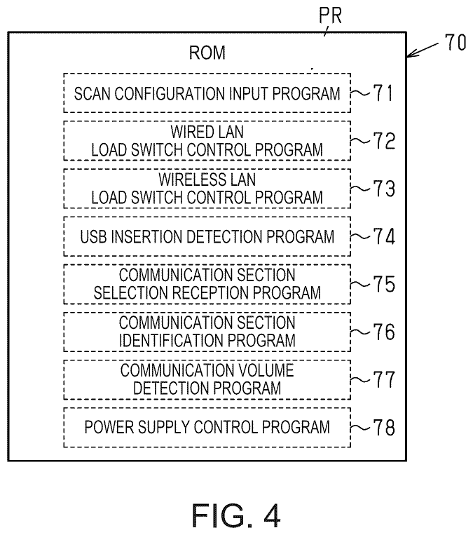

The configuration of the ROM 70 will be described with reference to FIG. 4. The ROM 70 stores a program PR executed by the CPU 80. The program PR includes various programs 71 to 78. In other words, the ROM 70 stores various programs, the programs include a scan configuration input program 71, a wired LAN load switch control program 72, a wireless LAN load switch control program 73, a USB insertion detection program 74, a communication section selection reception program 75, a communication section identification program 76, a communication volume detection program 77, and a power supply control program 78.

### Functional Configuration of Control Section 60

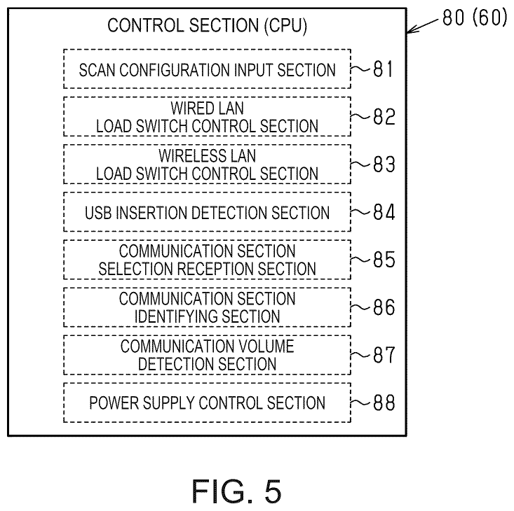

A configuration related to the function of the control section 60 will be described with reference to FIG. 5. The control section 60 includes the following sections 81 to 88, each of which is a functional section that is realized by the CPU 80 by executing the programs 71 to 78 stored in the ROM 70. The respective sections 81 to 88 are realized by the CPU 80 executing the respective programs 71 to 78. In other words, the control section 60 includes, as functional sections, the scan configuration input section 81, a wired LAN load switch control section 82, a wireless LAN load switch control section 83, a USB insertion detection section 84, a communication section selection reception section 85, a communication section identifying section 86, a communication volume detection section 87, and a power supply control section 88.

The scan configuration input section 81 receives a scan configuration selected by the user.

The wired LAN load switch control section 82 controls a load switch 33 (see FIG. 7) that switches between supply and cutoff (ON/OFF) of power to the physical layer of the wired LAN communication section 30.

The wireless LAN load switch control section 83 controls a load switch 43 (see FIG. 8) that switches between supply and cutoff (ON/OFF) of power to the physical layer of the wireless LAN communication section 40.

The USB insertion detection section 84 detects insertion of the plug 27A of the USB cable 27 into the USB port 50A. That is, the USB insertion detection section 84 detects the connection of the external device 100 to the USB interface 50 through the USB cable 27.

The communication section selection reception section 85 receives the communication unit selected by the user. Specifically, when there are a plurality of communication sections having high priority among the plurality of types of communication sections 30, 40, and 50, the communication section selection reception section 85 receives one communication section selected by the user among the plurality of communication sections.

The communication section identifying section 86 specifies one communication section to be used among the plurality of types of communication sections 30, 40, and 50. The communication section identifying section 86 specifies one communication section based on the selection by the user, the detection of the radio wave, and the detection of the connection of the cable 26 and 27.

When the identified one communication section is the USB communication section 50, the communication volume detection section 87 detects the communication volume of the USB communication section 50 in use.

The power supply control section 88 controls the amount of power supplied to the USB communication section 50 according to the presence or absence of communication, which was determined based on the communication volume of the USB communication section 50. The power supply control section 88 supplies the specified power supply amount when there is communication of the USB communication section 50, and reduces the power supply amount from the specified power supply amount when there is no communication. When communication of the USB communication section 50 is detected again after the power is reduced, the power supply control section 88 returns the power to be supplied to the specified power supply power.

### Circuit Configuration for USB Communication

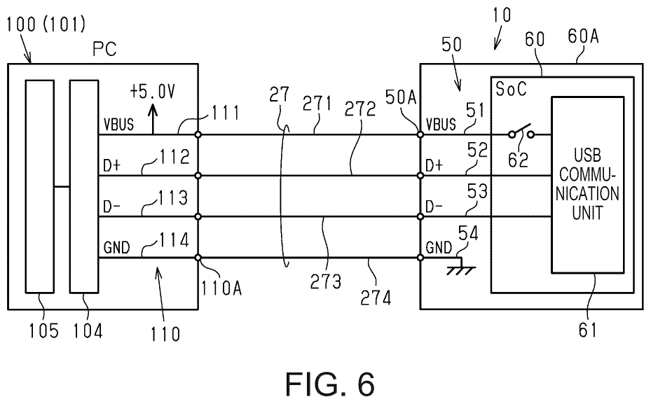

A configuration related to USB communication will be described with reference to FIG. 6. The electronic device 10 includes a USB interface 50 and the USB communication unit 61. The PC 101, which is an example of the external device 100, includes the read control section 105 that functions as a second control section, a USB communication unit 104, and a USB interface 110. The USB interface 110 is a USB communication section on the external device 100 side.

The USB interface 50 includes a power line 51 (VBUS,) a signal line 52 (D+,) a signal line 53 (D−,) and a ground line 54 (GND.) One end of the ground line 54 is grounded. One end of each of the power line 51 and the signal lines 52 and 53 (D−) is connected to the USB communication unit 61 within the control section 60. The other ends of the power line 51, the signal line 52 and 53, and the ground line 54 are connected to the USB ports 50A on the electronic device 10 side.

The control section 60 includes a switch 62 in the power line 51. The USB communication unit 61 controls to switch the switch 62. The USB communication unit 61, the USB interface 50, the switch 62, and the like constitute a USB communication-control section 60A.

The USB interface 110 includes a power line 111 (VBUS,) a signal line 112 (D+,) a signal line 113 (D−,) and a ground line 114 (GND.) One end of each of the power line 111 and the signal lines 112 and 113 is connected to the USB communication unit 104 in the PC 101. A power voltage of +5.0 V, for example, is applied to the power line 111. The other end of each of the power line 111, the signal lines 112 and 113, and the ground line 114 are connected to the USB ports 110A on the external device 100 side.

The USB cable 27 includes a power line 271 (VBUS,) a signal line 272 (D+,) a signal line 273 (D−,) and a ground line 274 (GND.) Both ends of each of the power line 271, the signal lines 272 and 273, and the ground line 274 are connected to the plug 27A (see FIG. 3).

As illustrated in FIG. 6, in a state where the electronic device 10 and the external device 100 are connected to each other through the USB cable 27, the USB communication units 61 and 104 are connected to each other through the power lines 111, 271 and 51. When the electronic device 10 and the external device 100 are connected to each other through the USB cable 27 in a state where the switch 62 is on, the USB power of the source voltage (+5 V) is supplied from the external device 100 to the USB communication unit 61. The USB communication unit 61 detects the USB connection based on the supplied source voltage. The USB communication unit 61 functions as a detection section that detects a USB connection. The USB communication unit 61 establishes communication by responding to a request from the USB communication unit 104 on the external device 100 side.

When the USB communication unit 61 turns off the switch 62, the supply of the USB power from the external device 100 to the USB communication unit 61 is stopped. The USB communication unit 61 can adjust the supply amount of the USB power by performing ON/OFF control of the switch 62.

### Configuration Related to Wired Lan Communication

Next, a configuration related to wired LAN communication will be described with reference to FIG. 7. The electronic device 10 includes the wired LAN communication section 30 that can communicate with the external device 100. The wired LAN communication section 30 includes an Ether IC 31 and the connector 32. The Ether IC 31 is a physical layer (PHY) of the OSI reference model. The connector 32 is, for example, an 8-pin type “RJ45.” The connector 32 has the LAN port 30A (see also FIG. 2).

The control section 60, the Ether IC 31, and the connector 32 are connected in series. A power voltage V+(for example, +3.3 V) is applied to the control section 60 through a power line 34. The control section 60 is connected to the Ether IC 31 through a signal line 35. The Ether IC 31 is connected to the connector 32 through a signal line 36. When wired LAN communication is used, the LAN port 30A of the electronic device 10 and a LAN port 120A (see FIG. 3) of the second wired LAN communication section 120 of the external device 100 are connected through the LAN cable 26.

The power voltage V+ is applied to the Ether IC 31 and the connector 32 through a power line 37. The load switch 33 is provided on the power line 37. The control section 60 controls to switch the load switch 33 on and off through a signal line 38.

When the load switch 33 is on, the power of the source voltage V+ is supplied to the Ether IC 31 and the connector 32. That is, the Ether IC 31 is turned on. When the Ether IC 31 is ON, wired communication with the external device 100 such as the PC 101 via the LAN cable 26 inserted into the LAN port 30A (also see FIG. 2) of the connector 32 is possible. When the load switch 33 is OFF, the supply of power to the Ether IC 31 and the connector 32 is cut off. Hereinafter, the load switch 33 that switches between supply and cutoff of power to the wired LAN communication section 30 is also referred to as a “first switch 33.”

### Configuration Related to Wireless LAN Communication

Next, a configuration related to wireless LAN communication will be described with reference to FIG. 8. The electronic device 10 includes the wireless LAN communication section 40 capable of communicating with the external device 100. The wireless LAN communication section 40 includes a Wi-Fi (registered trademark) module 41 and the Wi-Fi connector 42. The control section 60 is connected to the Wi-Fi module 41 via the Wi-Fi connector 42. A power voltage V+ (for example, +3.3 V) is applied to the control section 60 through a power line 44.

The control section 60 is connected to the Wi-Fi connector 42 through a signal line 45. The Wi-Fi connector 42 is connected to the Wi-Fi module 41 through a signal line 46. The power voltage V+ is applied to the Wi-Fi connector 42 through a power line 47. The load switch 43 is provided on the power line 47. The control section 60 controls to switch the load switch 43 ON/OFF through a signal line 48.

When the load switch 43 is on, the power of the source voltage V+ is supplied to the Wi-Fi connector 42. That is, the Wi-Fi connector 42 is turned on. When the Wi-Fi connector 42 is turned on, power is supplied to the Wi-Fi module 41. That is, the Wi-Fi module 41 is turned on. When the Wi-Fi module 41 is on, the Wi-Fi module 41 can wireless communicate with the external device 100 via the second wireless LAN communication section 130 included in the external device 100 such as the PC 101.

When the load switch 43 is in the OFF state, the power of the source voltage V+ is not supplied to the Wi-Fi connector 42. That is, the Wi-Fi connector 42 is turned off. When the Wi-Fi connector 42 is in the OFF state, no power is supplied to the Wi-Fi module 41. Therefore, the Wi-Fi module 41 is turned off. Hereinafter, the load switch 43 that switches between supply and cutoff of power to the wireless LAN communication section 40 is also referred to as a “second switch 43.”

As illustrated in FIGS. 7 and 8, the electronic device 10 includes the first switch 33 that switches between supply and cutoff of power to the wired LAN communication section 30, and the second switch 43 that switches between supply and cutoff of power to the wireless LAN communication section 40.

### Communication Setup Screen Set at Power-On Time of Electronic Device 10

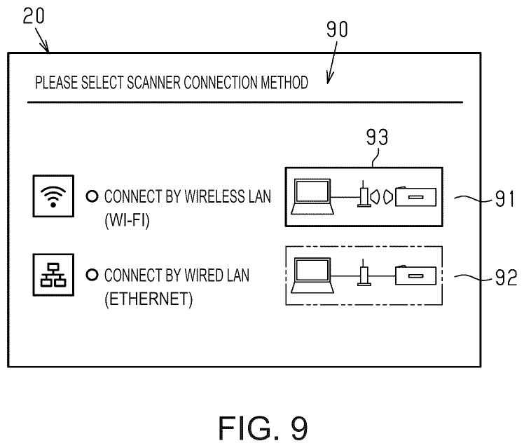

A communication setup screen 90 that can be set at the time of power activation of the electronic device 10 will be described with reference to FIG. 9. When the power switch 22 of the electronic device 10 is turned on to start the power supply, the home screen is displayed on the display section 20. The home screen includes a plurality of items for selecting a scan configuration and a communication method. The user selects, for example, a communication method setting item in the home screen by operating the touch panel 21. When the selection signal indicating that the communication method setting item is touched is input from the touch panel 21, the control section 60 causes the display section 20 to display the communication setup screen 90 illustrated in FIG. 9.

The communication setup screen 90 illustrated in FIG. 9 includes a wireless communication selection section 91 for selecting connection by a wireless LAN and a wired communication selection section 92 for selecting connection by a wired LAN. One communication section is selected by the user performing a touch operation on either of the two selection sections 91 or 92, for example. The communication setup screen 90 is a selection screen for prompting the user to select either the wired LAN communication section 30 or the wireless LAN communication section 40 that is mainly used for communication with the external device 100. The touch panel 21, which is an operation section, is operated when selecting either the wired LAN communication section 30 or the wireless LAN communication section 40. Either the two selection sections 91 or 92 is selected by an operation of the touch panel 21.

The control section 60 causes the display section 20 to display the selection result selected by the operation of the touch panel 21 on the communication setup screen 90. Specifically, when the control section 60 recognizes the communication method selected by the user through the touch operation on the touch panel 21 on the communication setup screen 90, the control section 60 displays an emphasized display section 93 illustrated in FIG. 9 for the communication method of the selection result. In the example illustrated in FIG. 9, when the wireless LAN connection is selected, the emphasized display section 93 indicated by a solid line in the diagram is displayed within the selection region. When the wired LAN connection is selected, the emphasized display section 93 indicated by a two-dot chain line in FIG. 9 is displayed. The emphasized display section 93 may surround the region of the item with a frame line, or may be another display form such as a change in the background color of the region of the item or active display. In the case of an active display, other inactive items are, for example, gray-out.

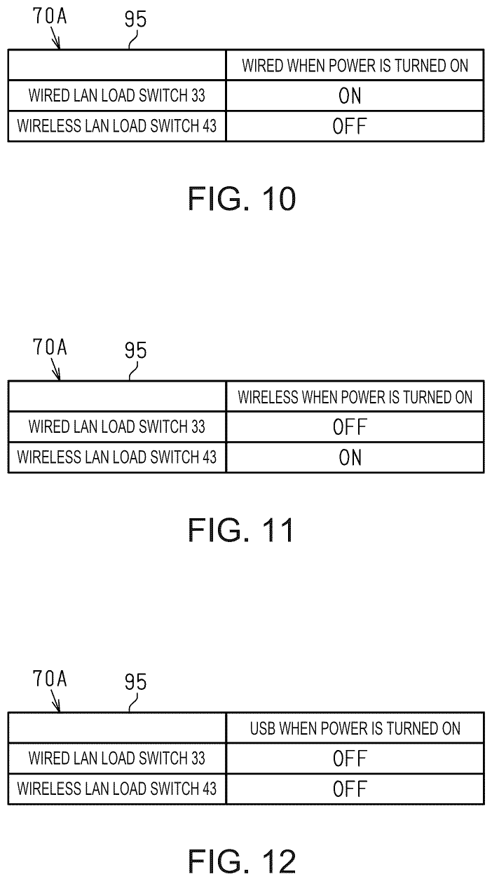

The control section 60 writes the selection result that is selected on the communication setup screen 90 in the non-volatile memory 70A as a communication setup information 95 (see FIGS. 10 to 12). The control section 60 controls the supply of power to the communication sections 30 and 40 based on the communication setup information 95 read from the non-volatile memory 70A each time the electronic device 10 is started up. When one communication section between the wired LAN communication section 30 and the wireless LAN communication section 40 is selected, the control section 60 turns on the switch corresponding to the one communication section and turns off the switch corresponding to the other communication section that was not selected.

Specifically, when the wired LAN communication section 30 is selected on the communication setup screen 90, the control section 60 turns on the first switch 33 and turns off the second switch 43. When the wireless LAN communication section 40 is selected on the communication setup screen 90, the control section 60 turns on the second switch 43 and turns off the first switch 33. When the USB communication unit 61 detects the USB connection with the external device 100 through the insertion of the USB cable 27 into the USB ports 50A, the control section 60 may turn off either the switches 33 or 43 and that are on in the communication section power supply control described later.

### Communication Setup Information Stored in Non-Volatile Memory

Next, the communication setup information 95 written in the ROM 70 will be described with reference to FIGS. 10 to 12. The communication setup information 95 is written in the rewritable non-volatile memory 70A in the ROM 70. The communication setup information 95 includes information of validity/invalidity of two types of the communication sections 30 and 40 that is set by the user selecting on the communication setup screen 90. As illustrated in FIGS. 10 to 12, the information indicating whether the two types of communication sections 30 and 40 are enabled or disabled may be represented by the ON/OFF information of the load switches 33 and 43 corresponding to the respective communication sections.

When the electronic device 10 is started up, the control section 60 refers to the communication setup information 95 to specify a communication section to be enabled from among the two types of communication sections 30 and 40. When the user operates the power switch 22 to start up the electronic device 10, the control section 60 performs switch control to turn on the switch corresponding to the communication section to be enabled and turn off the switch corresponding to the communication section to be disabled, based on the identification result.

FIG. 10 illustrates the communication setup information 95 that is set when the wired LAN connection is selected on the communication setup screen 90 illustrated in FIG. 9. In the non-volatile memory 70A shown in FIG. 10, information related to the ON/OFF status is stored for each of the wired LAN load switch 33 and the wireless LAN load switch 43, based on the settings configured by the user via the communication setup screen 90. Either the wireless LAN connection or the wired LAN connection selected on the communication setup screen 90 is enabled, and the other connection that is not selected is disabled. Of the two types of load switches 33 and 43, the switch corresponding to the enabled LAN connection is turned on, and the switch corresponding to the disabled LAN connection is turned off.

FIG. 10 illustrates the communication setup information 95 when the wired LAN connection is enabled when the electronic device 10 is started up by turning on the power. That is, the communication setup information 95 is information in which the wired LAN connection is enabled when the power is turned on. In the non-volatile memory 70A, the wired LAN load switch 33 is set to ON and the wireless LAN load switch 43 is set to OFF as the communication setup information 95.

When the electronic device 10 is started up, the control section 60 supplies power to the wired LAN communication section 30 and does not supply power to the wireless LAN communication section 40. Specifically, when the electronic device 10 is started up, the control section 60 refers to the communication setup information 95 illustrated in FIG. 10. The control section 60 turns on the wired LAN load switch 33 for which “ON” is set in the communication setup information 95, and turns off the wireless LAN load switch 43 for which “OFF” is set in the communication setup information 95.

FIG. 11 illustrates the communication setup information 95 stored in the non-volatile memory 70A when the wireless LAN connection is selected on the communication setup screen 90. In the non-volatile memory 70A, the wired LAN load switch 33 is set to OFF and the wireless LAN load switch 43 is set to ON as the communication setup information 95.

When the electronic device 10 is started up, the control section 60 supplies power to the wireless LAN communication section 40 and does not supply power to the wired LAN communication section 30. Specifically, when the electronic device 10 is started up, the control section 60 refers to the communication setup information 95 illustrated in FIG. 11. The control section 60 turns off the wired LAN load switch 33 for which “OFF” is set in the communication setup information 95, and turns on the wireless LAN load switch 43 for which “ON” is set in the communication setup information 95.

FIG. 12 illustrates the communication setup information 95 stored in the non-volatile memory 70A when neither wired nor wireless LAN connection is selected on the communication setup screen 90. The communication setup information 95 is also initial setting contents before the user sets the communication setup information 95. The non-volatile memory 70A stores the communication setup information 95 in which both the wired LAN load switch 33 and the wireless LAN load switch 43 are set to OFF.

When the electronic device 10 is started up, the control section 60 does not supply power to the wired LAN communication section 30 and the wireless LAN communication section 40. Specifically, when the electronic device 10 is started up, the control section 60 refers to the communication setup information 95 illustrated in FIG. 12. The control section 60 turns off both the wired LAN load switch 33 and the wireless LAN load switch 43 for which “OFF” is set in the communication setup information 95.

When the detection section detects connection to the USB communication section 50, which is an example of a third communication section, and neither the wired LAN communication section 30 nor the wireless LAN communication section 40 is selected, the control section 60 does not supply power to the wired LAN communication section 30 and the wireless LAN communication section 40.

### Operation of the Embodiment

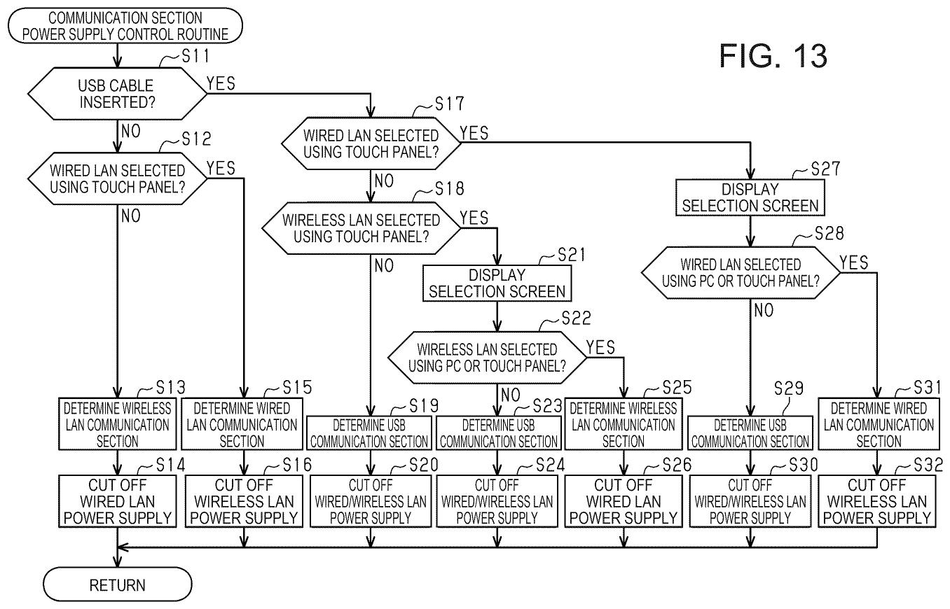

Next, the operation of the electronic device 10 will be described with reference to FIGS. 13 to 16 and the like. First, the user operates the power switch 22 to start up the electronic device 10. When the electronic device 10 is started up (when the power is turned on), the control section 60 controls the state (ON/OFF) of the load switches 33 and 43 based on the communication setup information 95, which is illustrated in FIGS. 10 to 12 and read from the non-volatile memory 70A.

In an initial state before setting on the communication setup screen 90, the communication setup information 95 in which both wired and wireless LAN connections illustrated in FIG. 12 are set to OFF is stored in the non-volatile memory 70A.

A user who wants to use the wired LAN connection in the electronic device 10 selects the wired communication selection section 92 on the communication setup screen 90. The user selects the wired communication selection section 92 by operating the touch panel 21. In this case, the communication setup information 95 illustrated in FIG. 10 is set in the non-volatile memory 70A.

A user who wants to use a wireless LAN connection in the electronic device 10 selects the wireless communication selection section 91 on the communication setup screen 90. The user selects the wireless communication selection section 91 by operating the touch panel 21. In this case, the communication setup information 95 illustrated in FIG. 11 is set in the non-volatile memory 70A.

A user who wants to use the USB connection in the electronic device 10 does not perform the setting on the communication setup screen 90, or returns the selection section to OFF by selecting the selection section of ON which has previously been set again by the operation of the touch panel 21. The non-volatile memory 70A stores the communication setup information 95 illustrated in FIG. 12.

The communication section power supply control routine illustrated in FIG. 13 executed by the control section 60 will be described below.

First, in step S11, the control section 60 judges whether or not a USB connection has been detected. When the user inserts, into the USB port 50A, the plug 27A that is on the opposite end of the USB cable 27 than the plug 27A connected to the USB interface 110 of the external device 100 or when the plug 27A is previously inserted into the USB port 50A, the USB interface 50, which functions as a detection section, detects the USB connection based on the insertion of the USB terminal. The control section 60 proceeds to step S12 when it is judged that there is no USB connection based on the detection result of the USB interface 50, and proceeds to step S17 when it is judged that there is a USB connection.

In step S12, the control section 60 judges whether or not the wired LAN is selected on the touch panel. The control section 60 judges whether or not the wired LAN is selected by referring to the communication setup information 95 illustrated in FIGS. 10 to 12 read from the non-volatile memory 70A. If the wired LAN is not selected, that is, if the wireless LAN is selected, the process proceeds to step S13, and if the wired LAN is selected, the process proceeds to step S15.

In step S13, the control section 60 determines the wireless LAN communication section 40 to be the power supply destination. That is, when insertion of the USB is not detected, the control section 60 determines the wireless LAN communication section 40 to be the power supply destination in the case of the communication setup information 95 illustrated in FIG. 11.

In the next step S14, the control section 60 cuts off the supply of power to the wired LAN communication section 30. In other words, among the wired LAN communication section 30 and the wireless LAN communication section 40, the control section 60 supplies power to the selected wireless LAN communication section 40, and does not supply power to the not-selected wired LAN communication section 30. Specifically, among the wired LAN communication section 30 and the wireless LAN communication section 40, the control section 60 turns ON the second switch 43 corresponding to the selected wireless LAN communication section 40, and turns OFF the first switch 33 corresponding to the not-selected wired LAN communication section 30. Therefore, when the electronic device 10 is started up, if the USB connection is not detected, then based on the communication setup information 95 illustrated in FIG. 11, the control section 60 supplies power to the selected wireless LAN communication section 40 and does not supply power to the not-selected wired LAN communication section 30.

In step S15, the control section 60 determines the wired LAN communication section 30 to be the power supply destination.

In the next step S16, the control section 60 cuts off the supply of power to the wireless LAN communication section 40. That is, the control section 60 supplies power to the wired LAN communication section 30 selected among the wired LAN communication section 30 and the wireless LAN communication section 40, and does not supply power to the wireless LAN communication section 40 that is not selected. Specifically, the control section 60 turns on the switch 33 corresponding to the selected wired LAN communication section 30 and turns off the switch 43 corresponding to the not-selected wireless LAN communication section 40, among the wired LAN communication section 30 and the wireless LAN communication section 40. Therefore, when the electronic device 10 is started up, if the USB connection is not detected, then based on the communication setup information 95 illustrated in FIG. 10, the control section 60 supplies power to the selected wired LAN communication section 30 and does not supply power to the not-selected wireless LAN communication section 40. In the case of the communication setup information 95 illustrated in FIG. 12, neither the wired LAN communication section 30 nor the wireless LAN communication section 40 is determined to be the power supply destination. Therefore, the control section 60 turns off both of the switches 33 and 43 to cut off supply of power to the wired LAN communication section 30 and the wireless LAN communication section 40.

In step S17, the control section 60 judges whether or not the wired LAN is selected on the touch panel. This judgment process is the same as that of step S12. The control section 60 refers to the communication setup information 95 illustrated in FIGS. 10 to 12 read from the non-volatile memory 70A.

The control section 60 proceeds to step S18 if the wired LAN is not selected, and proceeds to step S27 if the wired LAN is selected.

In step S18, the control section 60 judges whether or not the wireless LAN is selected on the touch panel. The control section 60 refers to the communication setup information 95 illustrated in FIGS. 10 to 12 read from the non-volatile memory 70A. The control section 60 proceeds to step S19 if the wireless LAN is not selected and proceeds to step S21 if the wireless LAN is selected.

In step S19, the control section 60 determines the USB communication section 50 to be the power supply destination.

That is, when insertion of the USB terminal is detected, the control section 60 determines the power supply destination to be the USB communication section 50 in the case of the communication setup information 95 illustrated in FIG. 12. In other words, the control section 60 determines the USB communication section 50, which is an example of a third communication section, to be the power supply destination if the USB communication unit 61, which functions as a detection section, detects that the external device 100 is communicably connected to the USB communication section 50, and neither the wired LAN communication section 30 nor the wireless LAN communication section 40 has been selected.

In the next step S20, the control section 60 cuts off the supply of power to the wired LAN communication section 30 and the wireless LAN communication section 40. In other words, if the USB communication unit 61, which functions as a detection section, detects a communicable connection of the external device 100 to the USB communication section 50, which is an example of a third communication section, and neither the wired LAN communication section 30 nor the wireless LAN communication section 40 has been selected, then the control section 60 does not supply power to either the wired LAN communication section 30 or the wireless LAN communication section 40. Specifically, the control section 60 turns off the first switch 33 corresponding to the wired LAN communication section 30 and turns off the second switch 43 corresponding to the wireless LAN communication section 40. Therefore, if the plug 27A of the USB cable 27 is inserted into the USB port 50A at the time of or after the start-up of the electronic device 10, then based on the communication setup information 95 illustrated in FIG. 12, the control section 60 does not supply power to either the not-selected wired LAN communication section 30 or the wireless LAN communication section 40.

In step S21, the control section 60 displays a selection screen. Here, the user can instruct the electronic device 10 to perform the predetermined operation (scan operation) using two methods. One is a method of selecting an operation setting (for example, a scan setup) by operating the PC 101, which is an example of the external device 100, and instructing the electronic device 10 to perform a predetermined operation (for example, a scan operation). The other is a method of selecting an operation setting by operating the touch panel 21 of the electronic device 10 and instructing the electronic device 10 to perform a predetermined operation. In the former case, the read control section 105 (for example, a scan driver), which is an example of a second control section, is activated in the PC 101. The control section 60 instructs the read control section 105 to display a selection screen 150 illustrated in FIG. 14 on the display section 102 of the PC 101. In the latter case, the control section 60 causes the display section 20 of the electronic device 10 to display the selection screen 160 illustrated in FIG. 15.

Prior to displaying the selection screen 150 illustrated in FIG. 14, the read control section 105 searches for a communication section of the electronic device 10 that can communicate with the PC 101. For example, when the user selects the wireless communication selection section 91 on the communication setup screen 90 illustrated in FIG. 9, the control section 60, which has referred to the communication setup information 95 illustrated in FIG. 11, turns off the first switch 33 and turns on the second switch 43. Therefore, as a result of the search, “wireless LAN” and “USB” are found as the currently effective connection methods. That is, when the USB cable 27 is inserted into the USB port 50A in a state where “wireless LAN” is previously selected, “wireless LAN” and “USB” are found as a result of the search.

The read control section 105 displays, on the display section 102, a selection screen 150 including a list of selection items 151 and 152 corresponding to the communication sections found as a result of the search. Specifically, the selection screen 150 illustrated in FIG. 14 includes a list of two selection items 151 and 152, which are “Network 01,” which refers to the common network communication name for the LAN communication sections 30 and 40, and “USB,” which is the name of the USB communication section. The selection item 151 and 152 displays the model name and the connection address of the electronic device 10. There is no situation where both the wired LAN communication section 30 and the wireless LAN communication section 40 are turned on. Therefore, when the user selects “network 01”, the control section 60 can determine whether the selected content is the wired LAN or the wireless LAN.

The selection screen 150 includes various buttons below the list of communication sections. The selection screen 150 includes an add button 153, a delete button 154, an update button 155, an OK button 156, and a cancel button 157. The control section 60 causes the display section 102 to display the selection screen 150, thereby prompting the user to select either the network (wireless LAN communication) or USB communication. The control section 60 prompts the read control section 105 to make a selection by causing the display section 102 to display a selection screen 150. The user selects one desired communication section from the selection items 152 and 152 in the list by operating the input operation section 103, and then operating the OK button 156. On a selection screen 160 displayed on the display section 20, a user who desires the wireless LAN selects the selection item 151, and a user who desires the “USB” selects a selection item 152. The control section 60 receives a selection result indicating that one communication section was selected by an operation on the touch panel 21.

Prior to the display of the selection screen 160 illustrated in FIG. 15, the control section 60 searches for communication sections of the external device 100 (the PC 101) that can communicate with the electronic device 10. The control section 60 displays, on the display section 20, the selection screen 160 including a list of selection items 161 and 162 corresponding to the communication sections found as a result of the search. The selection screen 160 includes, as the search result, the selection item 161 in which the connection method is “network” and the selection item 162 in which the connection method is “USB.” On the selection screen 160, a user who desires the wireless LAN selects the selection item 161, and a user who desires the “USB” selects the selection item 162.

When the connection to the USB communication section 50 is detected, if the wired LAN communication section 30 or the wireless LAN communication section 40 has previously been selected, the control section 60 prompts the user to select either the USB communication section 50 or the communication section that was previously selected. In this case, the control section 60 uses the display sections 20 and 102, which function as notification sections, to prompt the user to select either the USB communication section 50 or the communication section that was previously selected. In step S21 illustrated in FIG. 13, the display of selection screens 150 and 160 prompts the user to select either the wireless LAN communication section 40 or the USB communication section 50. The user selects the wireless LAN communication section 40 when the user desires wireless LAN communication, and selects the USB communication section 50 when the user desires USB communication. The control section 60 receives, from the read control section 105, a selection result indicating that one communication section was selected by the operation of the input operation section 103.

In step S22, the control section 60 determines whether or not the wireless LAN is selected at the PC or the touch panel. The control section 60 proceeds to step S23 if the wireless LAN is not selected and proceeds to step S25 if the wireless LAN is selected.

In step S23, the control section 60 determines the USB communication section to be the power supply destination.

In the next step S24, the control section 60 cuts off the supply of power to the wired LAN communication section 30 and the wireless LAN communication section 40.

In this way, after the display section 20 prompts the selection of either the wireless LAN communication section 40 or the USB communication section 50, the control section 60, upon receiving the selection of the USB communication section 50, does not supply power to the previously selected wireless LAN communication section 40 or to the not-selected wired LAN communication section 30 (step S24). On the other hand, when the selection of the previously selected wireless LAN communication section 40 is received, the control section 60 supplies power to the previously selected wireless LAN communication section 40, and does not supply power to the wired LAN communication section 30, which is the other communication section that was not previously selected (step S26).

When the USB communication section 50 is selected after selection is prompted by the display section 102 of the PC 101, the control section 60 does not supply power to either the wired LAN communication section 30 or the wireless LAN communication section 40 (step S24). On the other hand, when the wireless LAN communication section 40, which is the communication section that was previously selected, is selected, the control section 60 supplies power to the wireless LAN communication section 40, and does not supply power to the wired LAN communication section 30, which is the other communication section that was not previously selected (step S26).

When the connection to the USB communication section 50, which functions as the third communication section, is detected, the control section 60 accepts the selection of either the USB communication section 50 or the previously selected wireless LAN communication section 40 in a case where the wireless LAN communication section 40 was previously selected. The control section 60 communicates with the one communication section for which selection was received.

On the other hand, when the wired LAN is selected in step S17, the control section 60 executes the processes of step S28 to step S32. These processes are basically performed following the same procedure as for step S21 to step S26, except that the previously selected one communication section is the wired LAN communication section 30, instead of the wireless LAN communication section 40.

In step S27, the control section 60 displays a selection screen. When the control section 60 detects communication with the read control section 105 in the external device 100 (the PC 101), the control section 60 causes the display section 102 in the PC 101 to display the selection screen 150 illustrated in FIG. 14. The control section 60 causes the display section 20 of the electronic device 10 to display the selection screen 160 illustrated in FIG. 15. However, in FIG. 14, the selection item 151 for the network is used to select the wired LAN. In FIG. 15, the selection item 161 of a network is a selection item for selecting a wired LAN. By displaying selection screens 150 and 160 on the display sections 20 and 102, which function as notification sections, the control section 60 prompts the user to choose between the previously selected wired LAN communication section 30 and the USB communication section 50.

A user who desires wired LAN communication selects the selection item 151 of a network (wired LAN) on the selection screen 150 and then operates the OK button 156. The user selects the selection item 161 of a network (wired LAN) on the selection screen 160. On the other hand, a user who desires USB communication selects the USB selection item 152 on the selection screen 150 and then operates the OK button 156. The user selects the USB selection item 162 on the selection screen 160.

In step S28, the control section 60 judges whether or not the wired LAN is selected at the PC or the touch panel. The control section 60 proceeds to step S29 if the wired LAN is not selected and proceeds to step S31 if the wired LAN is selected.

In step S29, the control section 60 determines the USB communication section 50 to be the power supply destination.

In the next step S30, the control section 60 cuts off the supply of power to the wired LAN communication section 30 and the wireless LAN communication section 40.

In this way, after prompting the selection by the display section 20, when the control section 60 receives selection of the USB communication section 50, the control section 60 does not supply power to the previously selected wired LAN communication section 30 and the not previously selected wireless LAN communication section 40 (step S30). On the other hand, when the control section 60 receives selection of the previously selected wired LAN communication section 30, the control section 60 supplies power to the previously selected wired LAN communication section 30, and does not supply power to the wireless LAN communication section 40, which is the other communication section that was not previously selected (step S32).

When the USB communication section 50, which is an example of the third communication section, is selected after the selection is prompted by the display section 102 of the PC 101, the control section 60 does not supply power to the wired LAN communication section 30 and the wireless LAN communication section 40 (step S30). On the other hand, when the wired LAN communication section 30, which is the communication section that was previously selected, is selected, the control section 60 supplies power to the wired LAN communication section 30, and does not supply power to the wireless LAN communication section 40, which is the other communication section that was not previously selected (step S32).

When a connection to the USB communication section 50, which functions as a third communication section, is detected, if the wired LAN communication section 30 was previously selected, then the control section 60 accepts selection of either the USB communication section 50 or the previously selected wired LAN communication section 30. The control section 60 communicates with the one communication section for which selection was received.

When the USB communication section 50, which functions as the third communication section, is selected, the control section 60 is in a state (steps S24 and S30) in which power is not supplied to the communication section that was previously selected. In this state, when the detection section no longer detects the connection of the USB communication section 50 (negative judgement in step S11), the control section 60 supplies power to the communication section that was previously selected (steps S14 and S16).

After the power supply to the wired LAN communication section 30 and the wireless LAN communication section 40 is cut off, when the electronic device 10 is connected to a PC other than the PC 101, the user performs the following operation. The user selects the communication method setting item from the home screen displayed on the display section 20, and touches either the wireless communication selection section 91 or the wired communication selection section 92 on the communication setup screen 90 displayed on the display section 20, depending on the desired communication method. The control section 60 turns on the power supply to the one communication section selected by that touch. In this way, the electronic device 10 can communicate with another PC.

### USB Power Supply Control Routine

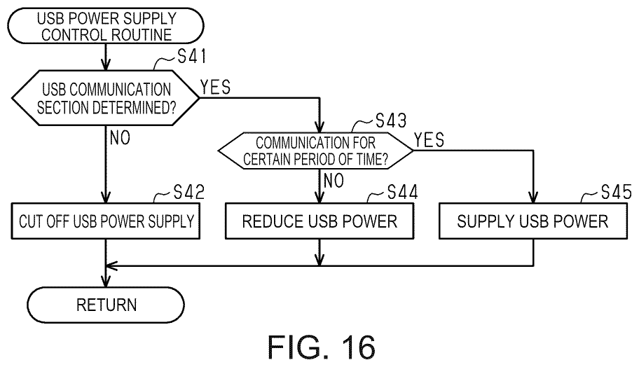

Next, the USB power supply control routine will be described with reference to FIG. 16. This routine is executed by the control section 60 in order to control the USB power supplied to the selected USB communication section 50 in the communication section power supply control shown in FIG. 13.

First, in step S41, the control section 60 judges whether or not the USB communication section 50 is determined. The control section 60 proceeds to step S42 if the USB communication section 50 is not determined and proceeds to step S43 if the USB communication section 50 is determined.

In step S42, the control section 60 cuts off the supply of the USB power. The control section 60 causes the USB communication unit 61 to turn off the switch 62. By this, the supply of the power supply power from the external device 100 to the USB communication section 50 is stopped. In this case, for example, the power consumption of the external device 100 can be suppressed.

In step S43, the control section 60 judges whether or not there is communication for a certain period of time. Specifically, the control section 60 acquires the communication volume at regular intervals after starting communication via the USB communication section 50, and judges whether the communication volume at regular intervals exceeds a threshold. When the communication volume of the USB communication section 50 at regular intervals is equal to or less than the threshold, it is determined that there is no communication for a certain period of time. The control section 60 proceeds to step S44 if there is no communication for a certain period of time, and proceeds to step S45 if there is communication for a certain period of time.

In step S44, the control section 60 reduces the USB power. In this way, when the communication volume at regular intervals becomes equal to or less than the threshold (negative judgement in step S43), the control section 60 reduces the power supplied to the USB communication section 50. The control section 60 instructs the USB communication unit 61 to intermittently operate the switch 62. The USB communication unit 61 intermittently operates the switch 62. The USB communication unit 61 intermittently supplies the power supply power to the USB communication section 50 by repeating ON/OFF of the switch 62. The control section 60 reduces the power supplied to the USB communication section 50 by switching from continuous supply to intermittent supply. By reducing the power supplied to the USB communication section 50, the power consumption of the external device 100, which is the power supply source, can be suppressed. Since the power supplied to the USB communication section 50 is reduced, the USB communication unit 61 can detect the presence or absence of communication from the external device 100 to the USB communication section 50.

In step S45, the control section 60 supplies USB power. The control section 60 switches supply of USB power from intermittent supply to continuous supply by maintaining the switch 62 in the ON state. By this, the power of the source voltage is supplied from the external device 100 to the USB communication section 50. In this way, after switching the power supply to the USB communication unit 61 to intermittent supply (step S44), if communication of the USB communication section 50 is detected, then the control section 60 switches power supply from intermittent supply to continuous supply. The process of step S43 during the USB power reduction may be replaced with a process of determining whether or not communication is detected. The process in step S43 may be the same during USB power supply and USB power reduction, or the communication volume threshold during USB power reduction may be set to a value lower than the threshold during USB power supply.

According to the present embodiment, the following effects are obtained.
(1) The electronic device 10 includes the wired LAN communication section 30 that can communicate with the external device 100, the wireless LAN communication section 40 that can communicate with the external device 100, and the control section 60. The control section 60 supplies power to the one communication section that was selected between the wired LAN communication section 30 and the wireless LAN communication section 40, and does not supply power to the other communication section that is not selected. According to this configuration, power is not supplied to the other communication section that was not selected between the wireless LAN communication section 40 and the wired LAN communication section 30. Therefore, in the electronic device 10 including the wired LAN communication section 30 and the wireless LAN communication section 40, power consumption related to communication of the electronic device 10 can be suppressed as compared with a configuration in which power is also supplied to a communication section not used for communication.
(2) The electronic device 10 includes the first switch 33 that turns on and off the power supply to the wired LAN communication section 30 and the second switch 43 that turns on and off the power supply to the wireless LAN communication section 40. The control section 60 turns on the switch corresponding to the one communication section that was selected between the wired LAN communication section 30 and the wireless LAN communication section 40, and turns off the switch corresponding to the other communication section that was not selected. According to this configuration, the supply of power to the other communication section that was not selected is cut off by turning off the switch corresponding to the other communication section that was not selected. By this, power consumption of the electronic device 10 can be suppressed compared to a configuration in which power is supplied to both the wired LAN communication section and the wireless LAN communication section.
(3) When the electronic device 10 is started up, the control section 60 supplies power to the wired LAN communication section 30 and does not supply power to the wireless LAN communication section 40. According to this configuration, when the electronic device 10 is started up, the power to the wireless LAN communication section 40 is cut off, and thus the power consumption of the electronic device 10 can be suppressed. For a user who frequently uses the wired LAN communication section 30, the user does not have to perform an operation of selecting the cutoff of the power to the wireless LAN communication section 40 each time, and thus the usability is good.
(4) When the electronic device 10 is started up, the control section 60 supplies power to the wireless LAN communication section 40 and does not supply power to the wired LAN communication section 30. According to this configuration, when the electronic device 10 is started up, the power to the wired LAN communication section 30 is cut off, and thus the power consumption of the electronic device 10 can be suppressed. For a user who frequently uses the wireless LAN communication section 40, it is possible to save the time and effort of the operation of selecting the cutoff of the power to the wired LAN communication section 30 every time, and thus the usability is good.
(5) The electronic device 10 includes the USB communication section 50, which is an example of a third communication section other than the wired LAN communication section 30 and the wireless LAN communication section 40. The control section 60 includes the USB communication unit 61, which is an example of a detection section that detects a communicable connection of the external device 100 to the USB communication section 50. When the USB communication unit 61 detects the connection to the USB communication section 50 and neither the wired LAN communication section 30 nor the wireless LAN communication section 40 is selected, the control section 60 does not supply power to the wired LAN communication section 30 and the wireless LAN communication section 40. According to this configuration, when the communicable connection of the external device 100 to the USB communication section 50, which is an example of the third communication section, is detected at the time of or after the start-up of the electronic device 10, the power to the wireless LAN communication section 40 and the wired LAN communication is cut off. Therefore, it is possible to suppress power consumption related to communication of the electronic device 10. For example, for a user who frequently uses the USB communication section 50, it is possible to save the time and effort of the operation of selecting the cutoff of the power to the wireless LAN communication section 40 and the wired LAN communication section 30 each time, and the usability is good.
(6) The electronic device 10 includes the USB communication section 50, which is an example of a third communication section other than the wired LAN communication section 30 and the wireless LAN communication section 40. The control section 60 includes the USB communication unit 61, which is an example of a detection section that detects a communicable connection of the external device 100 to the USB communication section 50. When the wireless LAN communication section 40 or the wired LAN communication section 30 was previously selected at the time of detecting the connection to the USB communication section 50, the control section 60 accepts the selection of either the USB communication section 50 or the communication section that was previously selected. The control section 60 communicates with the one communication section for which selection was received. According to this configuration, when the connection to the USB communication section 50, which is an example of the third communication section different from the wired LAN communication section 30 or the wireless LAN communication section 40 that was previously selected, is detected, it is possible to select either the USB communication section 50 or the communication section that was previously selected and perform communication. For example, even when the communication between the electronic device 10 and the external device 100 via the USB communication section 50 is selected, the communication via the USB communication section 50 can be performed while suppressing the power consumption related to the entire communication.
(7) When the control section 60 detects the connection to the USB communication section 50, which is an example of the third communication section, the control section 60 prompts, by the notification section, the user to select either the USB communication section 50 or the one communication section that was previously selected. When the selection of the USB communication section 50 is received thereafter, power is not supplied to one communication section that has previously been selected and the other communication section that was not previously selected. That is, when the selection of the USB communication section 50 is received, the control section 60 does not supply power to either the wired LAN communication section 30 or the wireless LAN communication section 40. On the other hand, when the selection of the one communication section that was previously selected is received, power is not supplied to the other communication section that was not previously selected. According to this configuration, when a connection to the USB communication section 50 is detected, regardless of whether the USB communication section 50 or the one communication section that was previously selected is chosen, the power consumption related to communication in the electronic device 10 can be reduced.
(8) When the one for which selection was recieved is the USB communication section 50, which is an example of a third communication section, the control section 60 acquires the communication volume at regular intervals after starting communication via the USB communication section 50. When the communication volume at regular intervals becomes equal to or less than the threshold, the control section 60 reduces the power supplied to the USB communication section 50. According to this configuration, even when the USB communication section 50 is selected, the power supplied to the USB communication section 50 is reduced when the communication volume acquired at regular intervals becomes equal to or less than the threshold. Therefore, power consumption related to the entire communication can be suppressed. The reduction of power consumption includes reduction of power to a value larger than zero and reduction of power to zero. In the former case, if the reduced power is power with which the presence or absence of communication by the USB communication section 50 can be detected, the power supplied to the USB communication section 50 when communication with the external device 100 is detected can be returned to the original value.
(9) When the control section 60 detects communication with the USB communication section 50, which is an example of a third communication section, the control section 60 reduces the power supplied to the USB communication section 50 by switching from continuous supply to intermittent supply. When the communication of the USB communication section 50 is detected after the switching to intermittent supply, the switching to continuous supply is performed. According to this configuration, since power supply is switched to intermittent supply, it is possible to detect the presence or absence of communication with the USB communication section 50 even after power is reduced. When communication of the USB communication section 50 is detected, the power supplied to the USB communication section 50 is returned to the original power before reduction, and thus stable communication by the USB communication section 50 can be realized.
(10) The external device 100 includes the read control section 105, which is an example of a second control section, the second communication section, the USB communication section 50, which is an example of a third communication section, the display section 20 configured as a notification section, and the input operation section 103. The read control section 105 gives an instruction to the electronic device 10 via communication. The second communication section is either a second wired LAN communication section 30 capable of communicating with the wired LAN communication section 30 of the electronic device 10 or the second wireless LAN communication section 40 capable of communicating with the wireless LAN communication section 40. The USB communication section 50 can communicate with the USB communication section 50 on the electronic device 10 side. The control section 60 prompts to make a selection by causing the read control section 105 to display the selection screen 160 on the display section 20. The control section 60 receives the selection result from the read control section 105, indicating which one communication section, either the USB communication section 50 or the previously selected communication section, was selected based on the operation of the input operation section 103. On the other hand, when the USB communication section 50 is selected, the control section 60 does not supply power to the wired LAN communication section 30 and the wireless LAN communication section 40. When the communication section that was previously selected is selected, the control section 60 supplies power to the communication section that was previously selected and does not supply power to the other communication section that is not previously selected. According to this configuration, the user who instructs to the electronic device 10 from the external device 100 can select one communication section by operating the input operation section 103 on the selection screen 160 displayed on the display section 102. The control section 60 supplies power to one communication section based on the selection result received from the read control section 105 through communication and does not supply power to the other communication section. Therefore, the power consumption of the electronic device 10 can be suppressed.
(11) In a state where the USB communication section 50, which is an example of a third communication section, is selected and power is not supplied to the communication section that was previously selected, when the USB communication unit 61, which is an example of a detection section, no longer detects the connection of the USB communication section 50, the control section 60 supplies power to the communication section that was previously selected. According to this configuration, when the connection of the USB communication section 50, which is an example of the third communication section, is no longer detected, power is supplied to the communication section that was previously selected, and thus, the usability is good for a user who frequently uses communication by the communication section that was previously selected.
(12) The electronic device 10 includes the display section 20 and the touch panel 21 that is an example of an operation section. The display section 20 displays the communication setup screen 90 as a selection screen for prompting the user to select either the wired LAN communication section 30 or the wireless LAN communication section 40. The touch panel 21 is operated to select either the wireless LAN communication section 40 or the wired LAN communication section 30. The control section 60 causes the display section 20 to display a selection result in which one is selected by the operation of the touch panel 21. With this configuration, the user can easily select the desired communication section and verify the selection result visually.

The above-described embodiment may be changed into the embodiment such as the following modified examples. Further, a combination of the above-described embodiment and the following modifications may be a further modification, and a combination of the following modifications may be a further modification.
The electronic device 10 may not include the third communication section. In other words, the electronic device 10 may be configured to include only the wired LAN communication section 30 and the wireless LAN communication section 40.
The third communication section is not limited to the USB communication section 50, which is a wired communication section. The third communication unit may be a wired communication section other than the USB communication section 50, or may be a wireless communication section. When the third communication section is a wired communication section, the third communication section may be a communication interface other than the USB communication section 50. When the third communication section is a wireless communication section, the third communication section may be a short-range wireless communication section such as a Bluetooth (registered trademark) communication section or an infrared communication section. The third communication section may be a FireWire (registered trademark) communication section or a Thunderbolt communication section. In the case of these third communication sections, when the third communication section is not selected on the selection screen, power may not be supplied to the third communication section.
The configuration for receiving the selection from the selection screen 150 of the external device 100 may be omitted. In this case, the selection can be received from the selection screen 160 displayed on the display section 20 of the electronic device 10.
The configuration for receiving the selection from the selection screen 160 displayed on the display section 20 of the electronic device 10 may be omitted. In this case, the selection can be received from the selection screen 150 of the external device 100.
Instead of the configuration in which the selection item is selected on the selection screens 150 and 160 displayed on the display sections 20 and 102, only a message prompting the selection may be displayed on the display sections 20 and 102. In this case, the user may open the selection screen from the home screen by operating the operation section and select a selection item corresponding to a desired communication section.
The configuration for selection on the selection screens 150 and 160 may be omitted. The control section 60 may be configured to select the USB communication section 50 when the USB communication unit 61, which functions as a detection section, detects a USB connection with the external device 100 through the USB cable 27. That is, the control section 60 may be configured to preferentially select the USB communication section 50 when the USB connection is detected, even if the wired LAN communication section 30 or the wireless LAN communication section 40 was previously selected.
In the case of reducing the power supplied to the USB communication section 50, the configuration is not limited to the configuration of switching from continuous supply to intermittent supply. The power supplied to the USB communication section 50 may be reduced in multiple stages of two or more stages. For example, the power may be supplied in two stages of the specified power supply power and the reduction power, or may be supplied in multiple stages of the specified power supply power and the reduction power of two or more stages.
The amount of power supplied to the USB communication section 50 may be “0” (zero) when the power is reduced.
Each functional section in the control section 60 is not limited to being realized by the CPU 80 and may be realized by hardware by an electronic circuit such as an application specific integrated circuit (ASIC) and a field programmable gate array (FPGA) or may be realized by both software and hardware. For example, some or all of the sections 81 to 88 constituting the control section 60 illustrated in FIG. 5 may be configured by hardware instead of software.

For example, the control section 60 may include an ASIC, and at least a part or all of the sections 81 to 88 may be configured by the ASIC or the FPGA.
The electronic device 10 may be a flatbed type image reading device 11 that does not include the automatic-document feeder 14. The electronic device 10 may be a sheet-feed type image reading device 11 that does not have a flatbed configuration and reads a document fed by the automatic-document feeder 14.
The electronic device 10 is not limited to the image reading device 11. For example, the electronic device 10 may be a multifunction device having an image reading function and a printing function. Further, the electronic device 10 may be a printing device that does not have an image reading function but has a printing function. In this case, the printing device may be for personal or domestic consumer use, business use, or industrial use.
The electronic device 10 may be a video device such as a television or an audio device such as a stereo audio, or may be a household electrical device such as a refrigerator, a washing machine, or a cooking appliance. The electronic device 10 may be a camera, a watch, smart glasses, or the like. The electronic device 10 may be a PC, a smartphone, a mobile phone, a personal digital assistant (PDA), a tablet PC, or the like, which is an device used as the external device 100 in the embodiment.

Hereinafter, technical ideas grasped from the above-described embodiment and the modified examples will be described together with effects.
[1] An electronic device includes a wired LAN

communication section configured to communicate with an external device; a wireless LAN communication section configured to communicate with an external device; and a control section, wherein the control section supplies power to one communication section that was selected between the wired LAN communication section and the wireless LAN communication section and does not supply power to the other communication section.

According to this configuration, power is not supplied to the other communication section that is not selected from the wired LAN communication section and the wireless LAN communication section. Therefore, in the electronic device including the wired LAN communication section and the wireless LAN communication section, it is possible to suppress power consumption related to communication, compared to a configuration in which power is also supplied to a communication section that is not used for communication.
[2] The electronic device according to [1] may further include a first switch configured to switch between supply and cutoff of power to the wired LAN communication section and a second switch that switches between supply and cutoff of power to the wireless LAN communication section, wherein when one communication section between the wired LAN communication section and the wireless LAN communication section is selected, then between the first switch and the second switch, the control section may turn on a switch that corresponds to the one communication section and turn off a switch that corresponds to the other communication section that was not selected. According to this configuration, the supply of power to the other communication section that is not selected is cut off. By this, power consumption of the electronic device 10 can be suppressed compared to a configuration in which power is supplied to both the wired LAN communication section and the wireless LAN communication section.
[3] The electronic device according to [1] or [2] may be such that when the electronic device is started up, the control section supplies power to the wired LAN communication section and does not supply power to the wireless LAN communication section. According to this configuration, when the electronic device is started up, the supply of power to the wireless LAN communication section is cut off, and thus the power consumption of the electronic device can be suppressed. For a user who frequently uses the wired LAN communication section, the user can save the trouble of selecting the cutoff of the power to the wireless LAN communication section each time, and the usability is good.
[4] The electronic device according to [1] or [2] may be such that when the electronic device is started up, the control section supplies power to the wireless LAN communication section and does not supply power to the wired LAN communication section. According to this configuration, when the electronic device is started up, power to the wired LAN communication section is cut off, and thus power consumption of the electronic device can be suppressed. For a user who frequently uses the wireless LAN communication section, the user can save the trouble of selecting the cutoff of the power to the wired LAN communication section each time, and the usability is good.
[5] The electronic device according to any one of [1] to [4] may further include a third communication section that is different from both the wired LAN communication section and the wireless LAN communication section and a detection section configured to detect a communicable connection between the external device and the third communication section, wherein when such a connection to the third communication section is detected by the detection section and neither of the wired nor wireless LAN communication sections had been selected, the control section supplies power to neither of them.

According to this configuration, when the connection of the external device to the third communication section is detected at the time of or after the start-up of the electronic device, the power to the wireless LAN communication section and the wired LAN communication is cut off. Therefore, it is possible to suppress power consumption related to communication of the electronic device. For example, for a user who frequently uses the third communication section, the user does not have to perform an operation of selecting the cutoff of the power to the wireless LAN communication section and the wired LAN communication section each time, and thus the usability is good.
[6] The electronic device according to any one of [1] to [4] may further include a third communication section that is different from both the wired LAN communication section and the wireless LAN communication section and a detection section configured to detect a communicable connection between the external device and the third communication section, wherein the control section when a connection to the third communication section is detected, and either the wired LAN communication section or the wireless LAN communication section is previously selected, causes the notification section to prompt the user to select either the third communication section or the one communication section that was previously selected and after prompting by the notification section, when a selection is made between the third communication section and the communication section that was previously selected, the control section performs communication with the one communication section for which selection was received.

According to this configuration, when connection to the third communication section is detected, it is possible to select either the third communication section or the communication section that was previously selected and perform communication. For example, even when communication between the electronic device and the external device via the third communication section is selected, the communication via the third communication section can be performed while suppressing power consumption related to the entire communication.
[7] The electronic device according to [6] may be such that the control section after prompting selection of the one communication section via the notification section when a connection to the third communication section was detected, when selection of the third communication section is received, does not supply power to either the one communication section that was previously selected or to the other communication section that was not previously selected, and when the selection of the one communication section that was previously selected is received, the control section does not supply power to the other communication section that was not previously selected.

According to this configuration, when connection to the third communication section is detected, the power consumption related to the communication of the electronic device can be suppressed even if either the third communication section or the previously selected one communication section is selected.
[8] The electronic device according to [6] may be such that the one for which selection was received by the control section is the third communication section and the control section acquires the communication volume measured at regular intervals after communication via the third communication section has started, and reduces power supplied to the third communication section when measured communication volume at each regular interval is less than or equal to a predetermined threshold.

According to this configuration, even when the third communication section is selected, the power supplied to the third communication section is reduced when the communication volume acquired at regular intervals becomes equal to or less than the threshold. Therefore, power consumption of the electronic device can be suppressed. The reduction of power consumption includes reduction of power to a value larger than zero and reduction of power to zero. In the former case, for example, if the power after reduction is power that enables detection of the presence or absence of communication with the third communication section, the power supplied to the third communication section when communication with the external device is detected can be returned to the original value.
[9] The electronic device according to [8] may be such that the control section reduces the power supplied to the third communication section by switching from continuous supply to intermittent supply when the communication volume is less than or equal to the threshold and switches back to continuous supply when communication activity via the third communication section is detected after switching to intermittent supply.

According to this configuration, since the supply is switched to intermittent supply, it is possible to detect the presence or absence of communication with the third communication section even after the power is reduced. When communication with the third communication section is detected, the power supplied to the third communication section is returned to the original power before the reduction, and thus stable communication by the third communication section can be realized.
[10] The electronic device according to [6] may be such that the external device includes a second control section configured to send instructions to the electronic device via communication, a second communication section that is either a second wired LAN communication section configured to communicate with the wired LAN communication section of the electronic device or a second wireless LAN communication section configured to communicate with the wireless LAN communication section of the electronic device, an external device side third communication section configured to communicate with the third communication section of the electronic device, a display section configured as a notification section, and an input operation section, wherein the control section causes the second control section to display a selection screen on the display section to prompt a selection and receives from the second control section a selection result indicating that the one communication section was, by an operation of the input operation section, selected from either the third communication section or the communication section that was previously selected, when the third communication section was selected, supplies power to neither the wired LAN communication section nor the wireless LAN communication section, and when the communication section that was previously selected is selected, supplies power to the communication section that was previously selected and does not supply power to the other communication section that was not previously selected.

According to this configuration, the user who gives an instruction from the external device to the electronic device can select one communication section by operating the input operation section on the selection screen displayed on the display section of the external device. The control section supplies power to the one communication section based on a selection result received from the second control section through communication, and does not supply power to the other communication section. Therefore, power consumption of the electronic device can be suppressed.
[11] The electronic device according to [7] may be such that in a state where, by the third communication section being selected, power is not supplied to the communication section that was previously selected, the control section supplies power to the communication section that was previously selected when the detection section no longer detects a connection to the third communication section. According to this configuration, when the connection of the third communication section is no longer detected, power is supplied to the communication section that was previously selected, and thus, the usability is good for a user who frequently uses communication by the communication section that was previously selected.
[12] The electronic device according to any one of [1] to [11] may further include a display section that displays a selection screen for prompting selection of either the wired LAN communication section or the wireless LAN communication section and an operation section configured to be operated when selecting one of the wired LAN communication section and the wireless LAN communication section, wherein the control section causes the display section to display a selection result indicating that the one communication section was selected by the operation of the operation section. With this configuration, the user can easily select the desired communication section and verify the selection result visually.

What is claimed is:

1. An electronic device comprising:
a wired LAN communication section configured to communicate with an external device;
a wireless LAN communication section configured to communicate with an external device; and
a control section, wherein
the control section supplies power to one communication section that was selected between the wired LAN communication section and the wireless LAN communication section and does not supply power to the other communication section.

2. The electronic device according to claim 1, further comprising:
a first switch that switches between supply and cutoff of power to the wired LAN communication section and
a second switch that switches between supply and cutoff of power to the wireless LAN communication section, wherein
when one communication section between the wired LAN communication section and the wireless LAN communication section is selected, then between the first switch and the second switch, the control section turns ON a switch that corresponds to the one communication section and turns OFF a switch that corresponds to the other communication section that was not selected.

3. The electronic device according to claim 1, wherein
when the electronic device is started up,
the control section supplies power to the wired LAN communication section and does not supply power to the wireless LAN communication section.

4. The electronic device according to claim 1, wherein
when the electronic device is started up,
the control section supplies power to the wireless LAN communication section and does not supply power to the wired LAN communication section.

5. The electronic device according to claim 1, further comprising:
a third communication section that is different from both the wired LAN communication section and the wireless LAN communication section and
a detection section configured to detect a communicable connection between the external device and the third communication section, wherein
when the detection section detects a connection to the third communication section and neither of the wired LAN communication section and the wireless LAN communication section is selected, the control section does not supply power to the wired LAN communication section or to the wireless LAN communication section.

6. The electronic device according to claim 1, further comprising:
a third communication section that is different from both the wired LAN communication section and the wireless LAN communication section and
a detection section configured to detect a communicable connection between the external device and the third communication section, wherein
when a connection to the third communication section is detected, and either the wired LAN communication section or the wireless LAN communication section is previously selected, the control section causes the notification section to prompt the user to select either the third communication section or the one communication section that was previously selected and
after prompting by the notification section, when a selection is made between the third communication section and the communication section that was previously selected, the control section performs communication with the one communication section for which selection was received.

7. The electronic device according to claim 6, wherein
the control section
after prompting selection of the one communication section via the notification section when a connection to the third communication section was detected,
when selection of the third communication section is received, does not supply power to either the one communication section that was previously selected or to the other communication section that was not previously selected, and
when selection of the one communication section that was previously selected is received, does not supply power to the other communication section that was not previously selected.

8. The electronic device according to claim 6 wherein
the one for which selection was received by the control section is the third communication section and
the control section acquires communication volume measured at regular intervals after communication via the third communication section has started, and reduces power supplied to the third communication section when measured communication volume at each regular interval is less than or equal to a threshold.

9. The electronic device according to claim 8 wherein
the control section
reduces the power supplied to the third communication section by switching from continuous supply to intermittent supply when the communication volume is less than or equal to the threshold and
switches back to continuous supply when communication activity via the third communication section is detected after switching to intermittent supply.

10. The electronic device according to claim 6,
the external device including
a second control section configured to send instructions to the electronic device via communication,
a second communication section that is either a second wired LAN communication section configured to communicate with the wired LAN communication section of the electronic device or a second wireless LAN communication section configured to communicate with the wireless LAN communication section of the electronic device,
an external device side third communication section configured to communicate with the third communication section of the electronic device,
a display section configured as a notification section, and
an input operation section, wherein
the control section
causes the second control section to display a selection screen on the display section to prompt a selection and
receives from the second control section a selection result indicating that the one communication section was, by an operation of the input operation section, selected from either the third communication section or the communication section that was previously selected,
when the third communication section was selected, supplies power to neither the wired LAN communication section nor the wireless LAN communication section, and
when the communication section that was previously selected is selected, supplies power to the communication section that was previously selected and does not supply power to the other communication section that was not previously selected.

11. The electronic device according to claim 7, wherein
in a state where, by the third communication section being selected, power is not supplied to the communication section that was previously selected, the control section supplies power to the communication section that was previously selected when the detection section no longer detects a connection to the third communication section.

12. The electronic device according to claim 1, further comprising:
a display section configured to display a selection screen for prompting selection of either the wired LAN communication section or the wireless LAN communication section and
an operation section configured to be operated when selecting one of the wired LAN communication section and the wireless LAN communication section, wherein
the control section causes the display section to display a selection result indicating that the selected communication section was selected by operation of the operation section.
